(19) United States
(12) Patent Application Publication
(10) Pub. No.: US 2026/0309197 A1
(43) Pub. Date: Oct. 8, 2026

(54) SYSTEM AND METHOD OF LOW-FREQUENCY BRAKE NOISE MITIGATION

(71) Applicant: GM GLOBAL TECHNOLOGY OPERATIONS LLC, Detroit, MI (US)

(72) Inventors: Brent D. Lowe, Milford, MI (US); Mark T. Riefe, Brighton, MI (US); Phu D. Pham, Hartland, MI (US); James A. Webster, Bloomfield Hills, MI (US)

(73) Assignee: GM GLOBAL TECHNOLOGY OPERATIONS LLC, Detroit, MI (US)

(21) Appl. No.: 19/169,113

(22) Filed: Apr. 3, 2025

(51) Int. Cl. F16D 65/00; B60T 8/171; B60T 8/172; B60T 8/26; B60T 8/58

(52) U.S. Cl. CPC F16D 65/0006; B60T 8/171; B60T 8/172; B60T 8/26; B60T 8/58; B60T 2210/20; B60T 2210/30; B60T 2220/00; B60T 2250/04

(57) ABSTRACT

A method of mitigating brake noise for a vehicle includes receiving, via a controller, a steering angle; determining, via the controller, whether a vehicle speed is less than or greater than a pre-determined vehicle speed; determining, via the controller, a vehicle grade when the vehicle speed is determined to be less than the pre-determined vehicle speed; implementing, via the controller, a first brake noise mitigation strategy that includes adjusting a brake pressure when it is determined that the vehicle grade is less than the pre-determined vehicle grade; and implementing, via the controller, a second brake noise mitigation strategy that includes adjusting the brake pressure when it is determined that the vehicle grade is greater than the pre-determined vehicle grade.

### INTRODUCTION

The concepts described herein relate generally to systems and methods of low-frequency brake noise mitigation for motorized vehicles. More specifically, aspects of this disclosure relate to mitigating and/or eliminating low-frequency brake noise during static steering events.

Motorized vehicles include braking systems that use friction to slow and/or stop the vehicle. There are two main types of braking systems used in motorized vehicles: disc brakes and drum brakes. Disc brakes may be used on the front wheels and/or the rear wheels of the motorized vehicle, while drum brakes are used only on the rear wheels of the motorized vehicle.

A vehicle braking system having disc brakes generally includes a brake pedal, a hydraulic system including brake fluid, brake calipers, brake pads and brake rotors. When a vehicle operator presses the brake pedal, the hydraulic system activates, sending brake fluid to brake calipers, each of which includes a pair of brake pads arranged within each of the brake calipers, adjacent to opposing sides of the brake rotor. The pressure of the brake fluid squeezes the brake pads against the brake rotors causing friction between the brake pads and the brake rotors, which slows and/or stops the motorized vehicle.

The hydraulic system may be activated by a mechanical connection between the brake pedal and the hydraulic system, or an electric system, known as brake-by-wire, which uses electrical signals to control the brakes of the motorized vehicle in place of the mechanical connection. Brake-by-wire has become more common, especially in hybrid and electric vehicles.

A static steering event refers to turning a steering wheel, and therefore, the front wheels of the motorized vehicle, when the motorized vehicle is not moving. Braking during a static steering event may result in brake noise due to stick-slip between the brake pads and the brake rotor, i.e., when a steering angle is increased with light brake pressure, torque can develop and, when that torque exceeds a brake torque, the brake rotor can slips between the brake pads causing a brake noise that is audible to the vehicle operator and bystanders. The brake noise may occur multiple times as the steering angle is increased.

### SUMMARY

In view of the above discussion, it is useful to develop a system and method of mitigating a low-frequency brake noise for motorized vehicles during static steering events.

A method of low-frequency brake noise mitigation may include receiving, via a controller, a steering input, for example but not limited to, a steering angle, and determining, via the controller, whether a vehicle speed is less than or greater than a pre-determined speed. The method may include determining, via the controller, a vehicle grade when the vehicle speed is determined to be less than the pre-determined vehicle speed, and implementing, via the controller, a first brake noise mitigation strategy that includes adjusting a brake pressure when it is determined that the vehicle grade is less than the pre-determined vehicle grade.

The pre-determined vehicle speed may be pre-defined during an initial vehicle calibration (IVC), and may include, for example but not limited to, 0.5 kilometers per hour (kph). The pre-determined vehicle grade, may include, for example but not limited to, a 1% grade, which may also be pre-defined during the IVC.

The first brake noise mitigation strategy may include a pre-defined brake noise mitigation strategy that may be pre-defined during the IVC.

According to one aspect of the present disclosure, a pre-defined brake noise mitigation strategy may include adjusting the brake pressure by removing a first brake pressure on a first axle, which may include a steered axle.

According to one aspect of the present disclosure, a pre-defined brake noise mitigation strategy may include adjusting a brake pressure by increasing a first brake pressure on a first axle, which may include a steered axle, to a pre-defined brake pressure.

According to one aspect of the disclosure, a pre-defined brake noise mitigation strategy may include adjusting a brake pressure by one of increasing or decreasing a corner brake pressure independently based upon a steering direction and a steering angle. Whether the brake pressure is increased or decreased may be pre-defined during an IVC.

According to one aspect of the disclosure, a pre-defined brake noise mitigation strategy may include adjusting the brake pressure by one of increasing or decreasing a corner brake pressure independently based upon an environmental condition.

The method of mitigating brake noise may further include detecting, via the controller, the environmental condition, and adjusting the brake pressure when the environmental condition detected may include one of a plurality of pre-defined environmental conditions. Such conditions may be pre-defined during an IVC.

According to another aspect of the disclosure, the method may further include implementing, via the controller, a second brake noise mitigation strategy. The second brake noise mitigation strategy may include adjusting a brake pressure when it is determined that a vehicle grade is greater than the pre-determined vehicle grade.

According to one aspect of the disclosure, the second brake noise strategy may include removing a first brake pressure on a first axle, e.g., a steered axle, and increasing a second brake pressure on a second axle, e.g., a non-steered axle. The second brake noise mitigation strategy may be implemented based on an initial vehicle calibration (IVC).

According to another aspect of the disclosure, implementing the second brake noise mitigation strategy may include detecting, via the controller, a system noise, identifying, via the controller, the system noise as a brake noise, and adjusting the brake pressure via the second brake noise mitigation strategy when the system noise is identified as the brake noise.

According to one aspect of the disclosure, the system noise may be detected via a microphone.

According to one aspect of the disclosure, the system noise may be detected via an accelerometer.

A vehicle braking system operable for mitigating brake noise is also disclosed. The vehicle braking system may include at least one disc brake, a brake control system in communication with the at least one disc brake, and a controller in communication with the brake control system. Communication may include, for example, hydraulic communication via hydraulic lines/pipes and/or electrical communication via electrical cabling/connections.

The at least one disc brake may include a brake caliper, a pair of brake pads arranged within the brake caliper, and a brake rotor arranged within the pair of brake pads.

The controller may be configured to receive a steering angle, determine whether a vehicle speed is less than or greater than a pre-determined vehicle speed, determine a vehicle gradewhen the vehicle speed is determined to be less than the pre-determined vehicle speed, implement a first brake noise mitigation strategy that includes adjusting a brake pressure when it is determined that the vehicle grade is less than the pre-determined vehicle grade, and implement a second brake noise mitigation strategy. The first brake noise mitigation strategy may include a pre-defined brake noise strategy that is pre-defined during the IVC. The second brake noise mitigation strategy includes adjusting a brake pressure when it is determined that the vehicle grade is greater than the pre-determined vehicle grade.

According to one aspect of the disclosure, the pre-defined brake noise mitigation strategy may include adjusting the brake pressure by removing a first brake pressure on a first axle, which may include a steered axle.

According to one aspect of the disclosure, the pre-defined brake noise mitigation strategy may include adjusting a brake pressure by increasing a first brake pressure on a first axle, which may include a steered axle, to a pre-defined brake pressure, which may be pre-defined during an IVC.

According to one aspect of the disclosure, the pre-defined brake noise mitigation strategy may include adjusting a brake pressure by increasing or decreasing a corner brake pressure independently based upon a steering direction and a steering angle.

According to one aspect of the disclosure, the pre-defined brake noise mitigation strategy may include adjusting a brake pressure by increasing or decreasing a corner brake pressure independently based upon an environmental condition.

The second brake noise strategy may include removing a first brake pressure on a first axle, which may include a steered axle, and increasing a second brake pressure on a second axle, which may include a non-steered axle.

A vehicle operable for mitigating brake noise in accordance with the disclosure is also disclosed. The vehicle may include a vehicle body, a powertrain may be arranged within the vehicle body, a pair of front wheels may be arranged adjacent to a front end of the vehicle, a pair of rear wheels may be arranged adjacent to a rear end of the vehicle, a pair of disc brakes, a brake control system, a controller, and a brake noise mitigation system.

The brake noise mitigation system may include the pair of disc brakes, the brake control system in communication with the pair of disc brakes, and the controller in communication with the brake control system.

One of the pair of disc brakes may be arranged adjacent to one front wheel of the pair of front wheels, and the other of the pair of disc brakes may be arranged adjacent the other front wheel of the pair of front wheels, respectively. Each of the pair of disc brakes may include a brake caliper, a pair of brake pads arranged within the brake caliper, and a brake rotor arranged within the pair of brake pads.

The controller may be configured to receive a steering angle, determine whether a vehicle speed is less than or greater than a pre-determined vehicle speed, determine a vehicle grade when the vehicle speed is determined to be less than the pre-determined vehicle speed, and implement a first brake noise mitigation strategy that includes adjusting a brake pressure when it is determined that the vehicle grade is less than the pre-determined vehicle grade. The first brake noise mitigation strategy is a pre-defined brake noise mitigation strategy that is pre-defined during an initial vehicle calibration (IVC). The controller is also configured to implement a second brake noise mitigation strategy that includes adjusting a brake pressure when it is determined that the vehicle grade is greater than the pre-determined vehicle grade. The second brake noise strategy includes removing a first brake pressure on a first axle, which may include a steered axle, and increasing a second brake pressure on a second axle, which may include a non-steered axle.

By selectively removing and/or increasing a brake pressure on one or more disc brake(s) arranged adjacent to one or more corners, disposed at opposing ends of a steered and/or a non-steered axle of a vehicle on a vehicle based on vehicle characteristics pre-defined during initial vehicle calibration and/or determined during vehicle operation including but not limited to brake pressures, low-frequency brake noise during static steering event can be mitigated and/or eliminated. The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a schematic illustration of a motorized vehicle having a vehicle braking system in accordance with the present disclosure.

FIG. 2 is a schematic illustration of a motorized vehicle braking system in accordance with the present disclosure.

FIG. 3 is a schematic illustration of a flow chart illustrating a method of low-frequency brake noise mitigation for a motorized vehicle that mitigates and/or eliminates low-frequency brake noise during static steering events.

The appended drawings are not necessarily to scale, and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

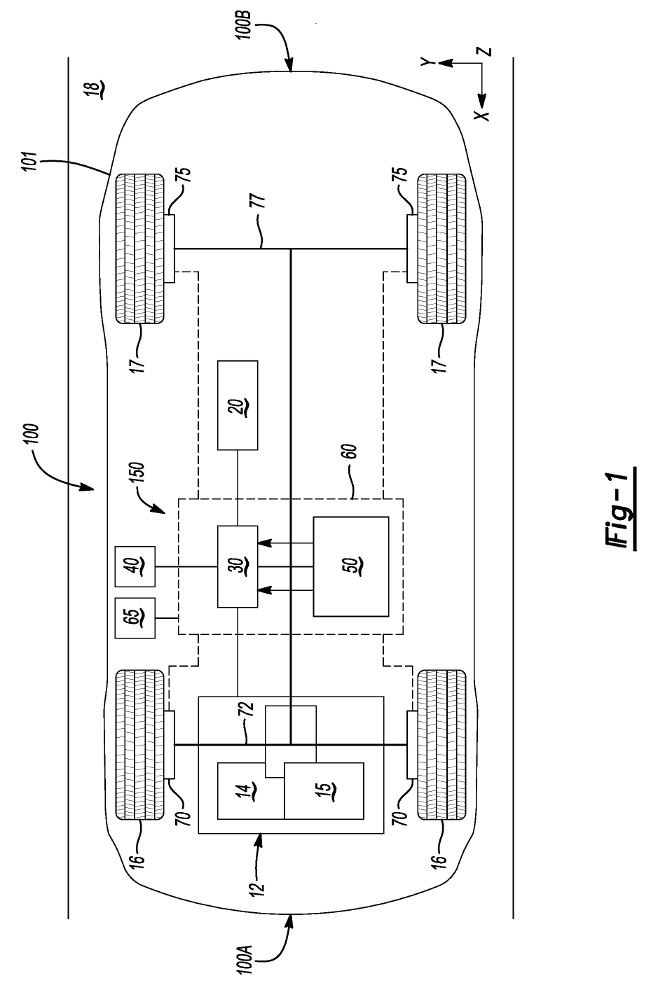

As illustrated in FIG. 1, a vehicle 100 includes a powertrain 12, a vehicle braking system 150, a low-frequency brake noise mitigation system 60, a plurality of sensors 65 in communication with the brake noise mitigation system 60, a controller 30, a display 40 and a brake control system 50. The vehicle 100 may include, but is not limited to a commercial vehicle, an industrial vehicle, a passenger vehicle, an aircraft, a watercraft, a train or the like.

The powertrain 12 includes a power-source 14 configured to generate a power-source torque T (not shown) for propulsion of the vehicle 100 via driven front wheels 16 relative to a road surface 18, when the vehicle 100 is configured as a front-wheel drive (FWD), via driven rear wheels 17 when the vehicle 100 is configured as a rear-wheel drive (RWD) vehicle, and the driven front wheels 16 and the driven rear wheels 17 when the vehicle 100 is configured as a four-wheel drive (4WD) or all-wheel drive (AWD). The power-source 14 is depicted as an internal combustion (IC) engine.

The front driven wheels 16 are arranged adjacent to opposing ends of a first axle 72, which includes a steered axle. The rear driven wheels 17 are arranged adjacent to opposing ends of a second axle 77, which includes a non-steered axle.

While the vehicle 100 is illustrated as being equipped with front axle steering, i.e., the first axle 72 arranged adjacent to the front end 100A of the vehicle 100 includes a steered axle, and the second axle 77 arranged adjacent to the rear end 100B of the vehicle 100 includes a non-steered axle, it should be appreciated that the vehicle 100 may alternatively be equipped with rear axle steering and/or four (4) wheel steering, in which the second axle 77 is arranged adjacent to the rear 100B of the vehicle 100 includes a steered axle.

As further illustrated in FIG. 1, the powertrain 12 may also include an additional power-source 15, for example but not limited to, an electric motor-generator or a fuel cell. The power-sources 14 and 15 may act in concert to power the vehicle 100.

The vehicle 100 may include a rechargeable energy storage system (RESS) 20 that is configured to store electrical power through heat-producing electro-chemical reactions and discharge DC power for energizing the vehicle 100 during use.

The vehicle braking system 150 includes the controller 30, the brake control system 50, and the low-frequency brake noise mitigation system 60, which are in communication with each disc brake 70, and each drum brake 75.

The disc brakes 70 are arranged adjacent to each of the front wheels 16, while drum brakes 75 are arranged adjacent to each of the rear wheels 17.

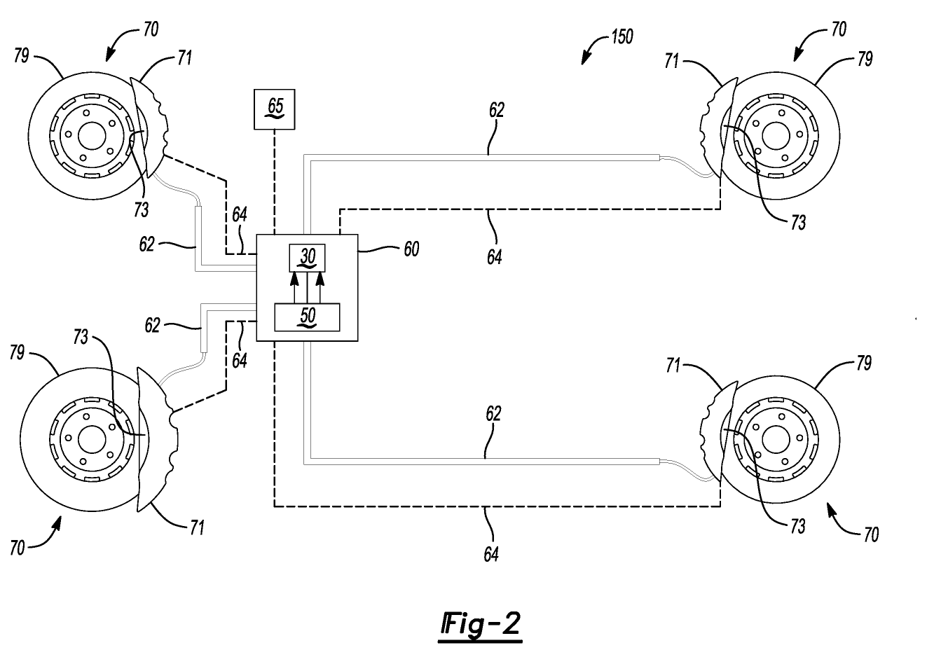

The brakes 70, 75 may be controlled by the brake control system 50 mechanically via hydraulic lines/pipes 62 and/or electrically via electrical cabling/connections 64, as further illustrated in FIG. 2.

While the vehicle 100 is illustrated as being equipped with disc brakes 70 at each of the front wheels 16 and rear drum brakes 75 at each of the rear wheels 17, it should be appreciated that the vehicle 100 may be equipped with, for example but not limited to, disc brakes 70 at each of the front wheels 16 and each of the rear wheels 17.

It should also be appreciated that the brake control system 50 may include an electric mechanical brake (EMB) system that includes electric motors (not shown) and/or actuators (not shown) disposed at each of the front wheels 16 and/or rear wheels 17 to apply the brakes 70, 75 to provide, for example but not limited to, independent wheel braking control, and/or reduced brake drag, without relying on hydraulic pressure.

The controller 30 is in communication with the powertrain 12, the RESS 20 (if so equipped), the display 40, and the low-frequency brake noise mitigation system 60 including the brake control system 50. The controller 30 is programmable and may include a central processing unit (CPU) that regulates various functions of the vehicle 100, the RESS 20 (if so equipped), the display 40, and the low-frequency brake noise mitigation system 60 including the brake control system 50.

In either of the above configurations, the controller 30 includes a processor and tangible, non-transitory memory, which includes instructions for operation of vehicle 100, the RESS 20 (if so equipped), the display 40, and the low-frequency brake noise mitigation system 60 programmed therein. The memory may be an appropriate recordable medium that participates in providing computer-readable data or process instructions. Such a recordable medium may take many forms, including, but not limited to, non-volatile media and volatile media.

Non-volatile media for the controller 30 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection.

Memory of the controller 30 may also include a flexible disk, hard disk, magnetic tape, another magnetic medium, a CD-ROM, DVD, another optical medium, etc. The controller 30 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controller 30 or accessible thereby, including, but not limited to predictive algorithms, may be stored in the memory and automatically executed to provide the required functionality of the vehicle 100 including but not limited to the low-frequency brake noise mitigation system 60 including the brake control system 50.

The controller 30 is disposed in the vehicle 100 and is in communication with the powertrain 12 including the IC engine 14 and the electric motor-generator 15 (if so equipped), the RESS 20 (if so equipped), the display 40, the low-frequency brake noise mitigation system 60 including the brake control system 50, and the vehicle 100.

The plurality of sensors 65 may include, for example but not limited to, a vehicle speed sensor, a vehicle position sensor, etc.

Referring to FIG. 2 with continued reference to FIG. 1, a schematic illustration of a vehicle braking system 150 including a brake control system is schematically illustrated.

The vehicle braking system 150 includes a low-frequency brake noise mitigation system 60, a controller 30, a braking control system 50, a plurality of sensors 65, and disc brakes 70, each of which are arranged adjacent to each of the front wheels 16 and adjacent to each of the rear wheels 17.

The brakes 70 may be controlled by the brake control system 50 mechanically via hydraulic lines/pipes 62 and/or electrically via electrical cabling/connections 64.

While the vehicle 100 is illustrated as being equipped with disc brakes 70 at each of the front wheels 16 and at each of the rear wheels 17, it should be appreciated that the vehicle 100 may be equipped with, for example but not limited to, disc brakes 70 at each of the front wheels 16 and drum brakes at each of the rear wheels 17.

It should also be appreciated that the brake system 50 may include an electric mechanical brake (EMB) system that includes electric motors (not shown) and/or actuators (not shown) disposed at each of the front wheels 16 and/or rear wheels 17 to apply the brakes 70, 75 to provide, for example but not limited to, independent wheel braking control, and/or reduced brake drag, without relying on hydraulic pressure.

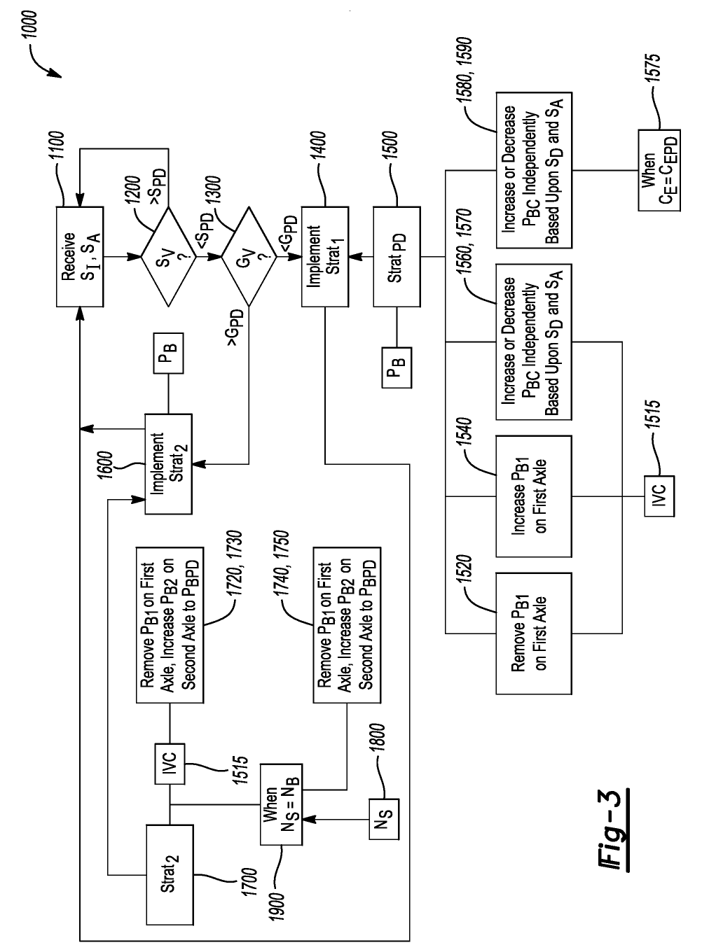

As illustrated in FIG. 3, a method 1000 of low-frequency brake noise mitigation includes receiving 1100, via a controller 30, a steering input S_{I}, for example but not limited to, a steering angle S_{A}; determining 1200, via the controller 30, whether a speed S_{V} of the vehicle 100 is less than or greater than a pre-determined speed S_{PD}; determining 1300, via the controller 30, a vehicle grade G_{V} when the speed S_{V} of the vehicle 100 is determined to be less than the pre-determined vehicle speed S_{V}; and implementing 1400, via the controller 30, a first brake noise mitigation strategy Strat₁ that includes adjusting 1500 a brake pressure P_{B} when it is determined that the vehicle grade G_{V} is less than the pre-determined vehicle grade G_{PD}.

The pre-determined speed S_{PD} of the vehicle 100 is pre-defined 1515 during an initial vehicle calibration (IVC), and may include, for example but not limited to, 0.5 kilometers per hour (kph). The pre-determined vehicle grade G_{PD}, may include, for example but not limited to, a 1% grade, which may also be pre-defined 1515 during the IVC.

The first brake noise mitigation strategy Strat₁ is a pre-defined brake noise mitigation strategy Strat_{PD} that is pre-defined 1515 during the IVC.

According to one aspect of the present disclosure, a pre-defined brake noise mitigation strategy Strat_{PD} includes adjusting 1500 the brake pressure P_{B} by removing 1520 a first brake pressure P_{B1} on a first axle 72, which includes a steered axle.

According to one aspect of the present disclosure, a pre-defined brake noise mitigation strategy Strat_{PD} includes adjusting 1500 a brake pressure P_{B} by increasing 1540 a first brake pressure P_{B1} on a first axle 72, which includes a steered axle, to a pre-defined brake pressure P_{BPD}.

According to one aspect of the disclosure, a pre-defined brake noise mitigation strategy Strat_{PD} includes adjusting 1500 a brake pressure P_{B} by increasing 1560 or decreasing 1570 a corner brake pressure P_{BC} independently based upon a steering direction S_{D} and a steering angle S_{A}. Whether the brake pressure P_{B} is increased 1560 or decreased 1570 is pre-defined 1515 during an IVC.

According to one aspect of the disclosure, a pre-defined brake noise mitigation strategy Strat_{PD} includes adjusting 1500 the brake pressure P_{B} by increasing 1580 or decreasing 1590 a corner brake pressure P_{BC} independently based upon an environmental condition C_{E}.

The method of brake noise mitigation 1000 may further include detecting 1575, via the controller 30, the environmental condition C_{E}; and increasing 1580 or decreasing 1590 the brake pressure P_{B} when the environmental condition C_{E} detected 1575 includes one of a plurality of pre-defined environmental conditions C_{EPD}, which may be pre-defined 1515 during an initial vehicle calibration (IVC).

According to another aspect of the disclosure, the method of brake noise mitigation 1000 further includes implementing 1600, via the controller 30, a second brake noise mitigation strategy Strat₂ that includes adjusting 1700 a brake pressure P_{B} when it is determined that a vehicle grade G_{V} is greater than the pre-determined vehicle grade G_{PD}.

According to one aspect of the disclosure, the second brake noise strategy Strat₂ includes removing 1720 a first brake pressure P_{B1} on a first axle 72, which includes a steered axle, and increasing 1730 a second brake pressure P_{B2} on a second axle 77, which includes a non-steered axle, wherein the second brake noise mitigation strategy Strat₂ is implemented 1600 based on an initial vehicle calibration (IVC).

According to another aspect of the disclosure, implementing 1600 the second brake noise mitigation strategy Strat₂ includes detecting 1800, via the controller 30, a system noise N_{S}; identifying 1900, via the controller 30, the system noise N_{S} as a brake noise N_{B}; and adjusting 1700 the brake pressure P_{B} via the second brake noise mitigation strategy Strat₂ when the system noise N_{S} is identified as the brake noise N_{B}.

According to one aspect of the disclosure, the system noise N_{S} is detected via a microphone.

According to one aspect of the disclosure, the system noise N_{S} is detected via an accelerometer.

A vehicle braking system 150 in accordance with one aspect of the disclosure includes at least one disc brake 70, a brake control system 50 in communication, for example hydraulic communication via hydraulic lines/pipes 62 and/or electrical communication via electrical cabling/connections 64, with the at least one disc brake 70, and a controller 30 in communication with the brake control system 50.

The at least one disc brake 70 includes a brake caliper 71, a pair of brake pads 73 arranged within the brake caliper 71, and a brake rotor 79 arranged within the pair of brake pads 73.

The controller 30 is configured to receive 1100 a steering angle S_{A}, determine 1200 whether a vehicle speed S_{V} is less than or greater than a pre-determined vehicle speed S_{PD}, determine 1300 a vehicle grade G_{V} when the vehicle speed S_{V} is determined 1200 to be less than the pre-determined vehicle speed S_{PD}, implement 1400 a first brake noise mitigation strategy Strat₁ that includes adjusting 1500 a brake pressure P_{B} when it is determined 1300 that the vehicle grade G_{V} is less than the pre-determined vehicle grade G_{PD}, wherein the first brake noise mitigation strategy Strat₁ is a pre-defined brake noise strategy Strat_{PD} that is pre-defined 1515 during an initial vehicle calibration (IVC), and implement 1600 a second brake noise mitigation strategy Strat₂ that includes adjusting 1700 a brake pressure P_{B} when it is determined 1300 that the vehicle grade G_{V} is greater than the pre-determined vehicle grade G_{PD}.

According to one aspect of the disclosure, the pre-defined brake noise mitigation strategy Strat_{PD} may include adjusting 1700 the brake pressure P_{B} by removing 1520 a first brake pressure P_{B1} on a first axle 72, which includes a steered axle.

According to one aspect of the disclosure, the pre-defined brake noise mitigation strategy Strat_{PD} may include adjusting 1500 a brake pressure P_{B} by increasing 1540 a first brake pressure P_{B1} on a first axle 72, which includes a steered axle, to a pre-defined brake pressure P_{BPD}, which may be pre-defined 1515 during an initial vehicle calibration (IVC).

According to one aspect of the disclosure, the pre-defined brake noise mitigation strategy Strat_{PD} may include adjusting 1500 a brake pressure P_{B} by one of increasing 1560 or decreasing 1570 a corner brake pressure P_{BC} independently based upon a steering direction S_{D} and a steering angle S_{A}.

According to one aspect of the disclosure, the pre-defined brake noise mitigation strategy Strat_{PD} may include adjusting 1500 a brake pressure P_{B} by one of increasing 1580 or decreasing 1590 a corner brake pressure P_{BC} independently based upon an environmental condition C_{E}.

The second brake noise strategy Strat₂ includes removing 1720, 1740 a first brake pressure P_{B1} on a first axle 72, which includes a steered axle, and increasing 1730, 1750 a second brake pressure P_{B2} on a second axle 77, which includes a non-steered axle.

A vehicle 100 operable for mitigating brake noise is also disclosed. The vehicle 100 includes a vehicle body 101, a powertrain 12 arranged within the vehicle body 101, the powertrain 12 configured to generate a torque for propulsion of the vehicle 100, a pair of front wheels 16 arranged adjacent to a front end 100A of the vehicle 100, a pair of rear wheels 17 arranged adjacent to a rear end 100B of the vehicle 100, a pair of disc brakes 70, a brake control system 50, a controller 30, and a brake noise mitigation system 60.

The brake noise mitigation system 60 includes the pair of disc brakes 70, the brake control system 50 in communication with the pair of disc brakes 70, and the controller 30 in communication with the brake control system 50.

One of the pair of disc brakes 70 is arranged adjacent to one of the pair of front wheels 16, and the other of the pair of disc brakes 70 is arranged adjacent the other of the pair of front wheels 16, respectively. Each of the pair of disc brakes 70 includes a brake caliper 71, a pair of brake pads 73 arranged within the brake caliper 71, and a brake rotor 79 arranged within the pair of brake pads 73.

The controller 30 is configured to receive 1100 a steering angle S_{A}, determine 1200 whether a vehicle speed S_{V} is less than or greater than a pre-determined vehicle speed S_{PD}, determine 1300 a vehicle grade G_{V} when the vehicle speed S_{V} is determined 1200 to be less than the pre-determined vehicle speed S_{PD}, implement 1400 a first brake noise mitigation strategy Strat₁ that includes adjusting a brake pressure P_{B} when it is determined 1300 that the vehicle grade G_{V} is less than the pre-determined vehicle grade G_{PD}, wherein the first brake noise mitigation strategy Strat₁ is a pre-defined brake noise mitigation strategy Strat_{PD} that is pre-defined 1515 during an initial vehicle calibration (IVC), and implement 1600 a second brake noise mitigation strategy Strat₂ that includes adjusting 1700 a brake pressure P_{B} when it is determined 1300 that the vehicle grade G_{V} is greater than the pre-determined vehicle grade G_{PD}, wherein the second brake noise strategy Strat₂ includes removing 1720, 1740 a first brake pressure P_{B1} on a first axle 72, which includes a steered axle, and increasing 1730, 1750 a second brake pressure P_{B2} on a second axle 77, which includes a non-steered axle.

By selectively removing and/or increasing a brake pressure on one or more disc brake(s) arranged adjacent to one or more corners, disposed at opposing ends of a steered and/or a non-steered axle of a vehicle on a vehicle based on vehicle characteristics pre-defined during initial vehicle calibration and/or determined during vehicle operation including but not limited to brake pressures, low-frequency brake noise during static steering event can be mitigated and/or eliminated.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. A method of brake noise mitigation for a vehicle, the method comprising:
receiving, via a controller, a steering angle;
determining, via the controller, whether a vehicle speed is less than or greater than a pre-determined vehicle speed;
determining, via the controller, a vehicle grade when the vehicle speed is determined to be less than the pre-determined vehicle speed; and
implementing, via the controller, a first brake noise mitigation strategy that includes adjusting a brake pressure when it is determined that the vehicle grade is less than a pre-determined vehicle grade.

2. The method of brake noise mitigation as recited in claim 1, wherein the first brake noise mitigation strategy is a pre-defined brake noise mitigation strategy that is pre-defined during an initial vehicle calibration.

3. The method of brake noise mitigation as recited in claim 2, wherein the pre-defined brake noise mitigation strategy includes adjusting the brake pressure by removing a first brake pressure on a first axle.

4. The method of brake noise mitigation as recited in claim 2, wherein the pre-defined brake noise mitigation strategy includes adjusting the brake pressure by increasing a first brake pressure on a first axle to a pre-defined brake pressure.

5. The method of brake noise mitigation as recited in claim 2, wherein the pre-defined brake noise mitigation strategy includes adjusting the brake pressure by one of increasing or decreasing a corner brake pressure independently based upon a steering direction and a steering angle, wherein whether the brake pressure is increased or decreased is pre-defined during an initial vehicle calibration.

6. The method of brake noise mitigation as recited in claim 2, wherein the pre-defined brake noise mitigation strategy includes adjusting the brake pressure by increasing or decreasing a corner brake pressure independently based upon an environmental condition.

7. The method of brake noise mitigation as recited in claim 6, further including:
detecting, via the controller, the environmental condition; and
adjusting the brake pressure when the environmental condition detected includes one of a plurality of pre-defined environmental conditions.

8. The method of brake noise mitigation as recited in claim 1, further including:
implementing, via the controller, a second brake noise mitigation strategy that includes adjusting the brake pressure when it is determined that the vehicle grade is greater than the pre-determined vehicle grade.

9. The method of brake noise mitigation as recited in claim 8, wherein the second brake noise strategy includes removing a first brake pressure on a first axle and increasing a second brake pressure on a second axle.

10. The method of brake noise mitigation as recited in claim 9, further comprising implementing the second brake noise mitigation strategy based on an initial vehicle calibration.

11. The method of brake noise mitigation as recited in claim 9, wherein implementing the second brake noise mitigation strategy includes:
detecting, via the controller, a system noise;
identifying, via the controller, the system noise as a brake noise; and
adjusting the brake pressure via the second brake noise mitigation strategy when the system noise is identified as a brake noise.

12. The method of brake noise mitigation as recited in claim 11, wherein detecting the system noise includes using a microphone to detect the system noise.

13. The method of brake noise mitigation as recited in claim 11, wherein detecting the system noise includes using an accelerometer to detect the system noise.

14. A vehicle braking system operable for mitigating brake noise, the vehicle braking system comprising:
at least one disc brake including:
a brake caliper;
a pair of brake pads arranged within the brake caliper; and
a brake rotor arranged within the pair of brake pads; and
a brake control system in communication with the at least one disc brake; and
a controller in communication with the brake control system, the controller configured to:
receive a steering angle;
determine whether a vehicle speed is less than or greater than a pre-determined vehicle speed;
determine a vehicle grade when the vehicle speed is determined to be less than the pre-determined vehicle speed;
implement a first brake noise mitigation strategy that includes adjusting a brake pressure when it is determined that the vehicle grade is less than the pre-determined vehicle grade, wherein the first brake noise mitigation strategy is a pre-defined brake noise strategy that is pre-defined during an initial vehicle calibration; and
implement a second brake noise mitigation strategy that includes adjusting a brake pressure when it is determined that the vehicle grade is greater than the pre-determined vehicle grade.

15. The vehicle braking system as recited in claim 14, wherein the pre-defined brake noise mitigation strategy includes adjusting the brake pressure by releasing a first brake pressure on a first axle.

16. The vehicle braking system as recited in claim 15, wherein the pre-defined brake noise mitigation strategy includes adjusting the brake pressure by increasing a first brake pressure on a first axle to a pre-defined brake pressure.

17. The vehicle braking system as recited in claim 15, wherein the pre-defined brake noise mitigation strategy includes adjusting the brake pressure by one of increasing or decreasing a corner brake pressure independently based upon a steering direction and a steering angle.

18. The vehicle braking system as recited in claim 15, wherein the pre-defined brake noise mitigation strategy includes adjusting the brake pressure by increasing or decreasing a corner brake pressure independently based upon an environmental condition.

19. The vehicle braking system as recited in claim 14, wherein the second brake noise strategy includes removing a first brake pressure on a first axle and increasing a second brake pressure on a second axle.

20. A vehicle operable for mitigating brake noise, comprising:
a vehicle body;
a powertrain arranged within the vehicle body, the powertrain configured to generate a torque for propulsion of the vehicle;
a pair of front wheels arranged adjacent to a front end of the vehicle;
a pair of rear wheels arranged adjacent to a rear end of the vehicle;
a brake noise mitigation system comprising:
a pair of disc brakes, wherein one of the pair of disc brakes is arranged adjacent to one of the pair of front wheels, and the other of the pair of disc brakes arranged adjacent the other of the pair of front wheels, respectively, wherein each of the pair of disc brakes includes:
a brake caliper;
a pair of brake pads arranged within the brake caliper; and
a brake rotor arranged within the pair of brake pads; and
a brake control system in communication with the pair of disc brakes; and
a controller in communication with the brake control system, the controller configured to:
receive a steering angle;
determine whether a vehicle speed is less than or greater than a pre-determined vehicle speed;
determine a vehicle grade when the vehicle speed is determined to be less than the pre-determined vehicle speed;
implement a first brake noise mitigation strategy that includes adjusting a brake pressure when it is determined that the vehicle grade is less than the pre-determined vehicle grade, wherein the first brake noise mitigation strategy is a pre-defined brake noise mitigation strategy that is pre-defined during an initial vehicle calibration; and
implement a second brake noise mitigation strategy that includes adjusting a brake pressure when it is determined that the vehicle grade is greater than the pre-determined vehicle grade, wherein the second brake noise strategy includes removing a first brake pressure on a first axle and increasing a second brake pressure on a second axle.
